(19) United States
(12) Patent Application Publication
(10) Pub. No.: US 2024/0021857 A1
(43) Pub. Date: Jan. 18, 2024

(54) ELECTROCHEMICAL CELL

(71) Applicant: DENSO CORPORATION, Kariya-city (JP)

(72) Inventors: Hironori TATSUMI, Kariya-city (JP); Nobuhiko MATSUDA, Kariya-city (JP); Shota KINOSHITA, Nisshin-city (JP); Atsuhito OTA, Nisshin-city (JP)

(21) Appl. No.: 18/349,205

(22) Filed: Jul. 10, 2023

(30) Foreign Application Priority Data
Jul. 15, 2022 (JP) 2022-114042

(51) Int. Cl. H01M 8/0656; H01M 4/88; H01M 4/86

(52) U.S. Cl. CPC H01M 8/0656; H01M 4/8875; H01M 4/8626

(57) ABSTRACT

An electrochemical cell includes a working electrode and a counter electrode. The working electrode is configured to adsorb and desorb a recovery target gas from a mixed gas containing the recovery target gas by electrochemical reaction. The counter electrode is configured to exchange electrons with the working electrode. The working electrode has a volume porosity that is equal to or greater than a volume porosity of the counter electrode.

### CROSS REFERENCE TO RELATED APPLICATION

The present application claims the benefit of priority from Japanese Patent Application No. 2022-114042 filed on Jul. 15, 2022. The entire disclosure of the above application is incorporated herein by reference.

### TECHNICAL FIELD

The present disclosure relates to an electrochemical cell.

### BACKGROUND

Conventionally, there has been known an electrochemical cell including a working electrode and a counter electrode.

### SUMMARY

The present disclosure provides an electrochemical cell including a working electrode and a counter electrode. The working electrode is configured to adsorb and desorb a recovery target gas from a mixed gas containing the recovery target gas by electrochemical reaction. The counter electrode is configured to exchange electrons with the working electrode. The working electrode has a volume porosity that is equal to or greater than a volume porosity of the counter electrode.

### BRIEF DESCRIPTION OF DRAWINGS

Objects, features and advantages of the present disclosure will become apparent from the following detailed description made with reference to the accompanying drawings. In the drawings:

FIG. 1 is a conceptual diagram illustrating an overall configuration of a carbon dioxide recovery system according to an embodiment;

FIG. 2 is an explanatory diagram illustrating a carbon dioxide recovery device according to the embodiment;

FIG. 3 is a cross-sectional view of an electrochemical cell according to the embodiment;

FIG. 4 is an explanatory diagram for explaining a structure of a working electrode;

FIG. 5 is an explanatory diagram for explaining a structure of a counter electrode;

FIG. 6 is an explanatory diagram for explaining working-electrode pores;

FIG. 7 is an explanatory diagram for explaining counter-electrode pores;

FIG. 8 is a graph showing a relationship between the number of cycles and an adsorption Faraday efficiency;

FIG. 9 is a graph showing a relationship between the number of cycles and an integrated adsorption amount;

FIG. 10 is a graph showing a relationship between an average circle equivalent diameter of the working-electrode pores and a molecular diffusion coefficient of carbon dioxide;

FIG. 11 is a graph showing a relationship between a film thickness of a working electrode film and a calculated value of a carbon dioxide adsorption rate;

FIG. 12 is a graph showing a relationship between the film thickness of the working electrode film and an actual measurement value of a carbon dioxide adsorption rate; and

FIG. 13 is a graph showing a relationship between the film thickness of the working electrode film and a diffusion reaching concentration.

### DETAILED DESCRIPTION

Next, a relevant technology is described only for understanding the following embodiments. Electrochemical cells may be used in carbon dioxide recovery systems that separate carbon dioxide (CO₂), which is a recovery target gas, from mixed gases containing carbon dioxide by electrochemical reaction. In the electrochemical cells, carbon dioxide containing gas is supplied to cathodes of electrochemical cells while a potential difference is applied between the cathodes and anodes, so that an electrochemical reaction in which CO₃²⁻ is produced from CO₂ and an electrochemical reaction in which CO₂ is produced from CO₃²⁻ are performed.

When electrochemical cells are used for electric double layer capacitors (EDLCs), a technique of densifying the electrochemical cells by press working or the like may be employed in order to improve an energy density.

However, according to a study by the present inventors, it has become clear that, in a case where an electrochemical cell is used in a carbon dioxide recovery system, if the electrochemical cells is compressed by press working or the like, an adsorption performance of carbon dioxide decreases.

An electrochemical cell according to an aspect of the present disclosure includes a working electrode and a counter electrode. The working electrode is configured to adsorb and desorb a recovery target gas from a mixed gas containing the recovery target gas by electrochemical reaction. The counter electrode is configured to exchange electrons with the working electrode. The working electrode has a volume porosity that is equal to or greater than a volume porosity of the counter electrode.

According to the above-described configuration, a diffusibility of the recovery target gas can be improved in the working electrode, and thus a permeability of the recovery target gas can be secured. As a result, an adsorption performance of the recovery target gas can be improved.

### Embodiment

An embodiment of the present disclosure will be described with reference to the drawings. In the present embodiment, an electrochemical cell according to the present disclosure is applied to a carbon dioxide recovery system that separates and recovers carbon dioxide from a mixed gas containing carbon dioxide. Thus, a recovery target gas in the present embodiment is carbon dioxide (CO₂).

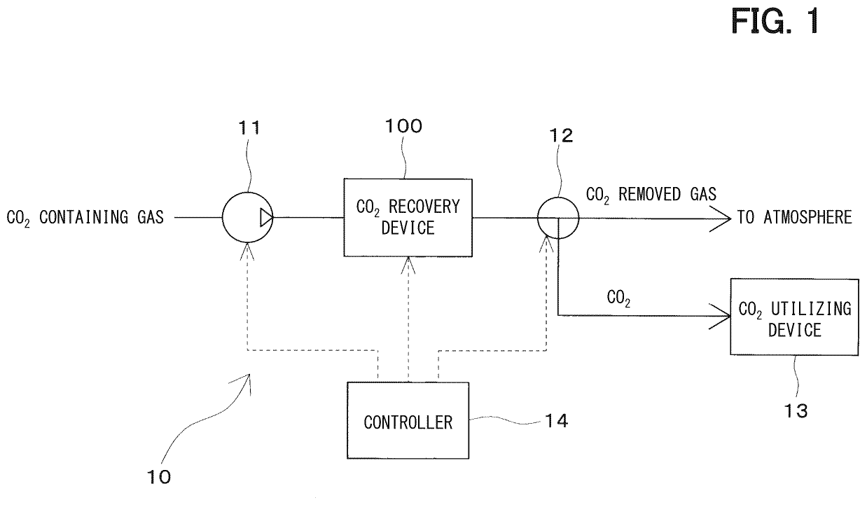

As shown in FIG. 1, a carbon dioxide recovery system 10 of the present embodiment includes a compressor 11, a carbon dioxide recovery device 100, a passage switching valve 12, a carbon dioxide utilizing device 13, and a controller 14.

The carbon dioxide recovery device 100 is a device that separates carbon dioxide from the mixed gas and recovers carbon dioxide. The carbon dioxide recovery device 100 discharges carbon dioxide removed gas that is gas after carbon dioxide is recovered from the mixed gas, or carbon dioxide that is recovered from the mixed gas. The configuration of the carbon dioxide recovery device 100 will be described in detail later.

The mixed gas is a carbon dioxide-containing gas that contains carbon dioxide. The mixed gas also contains gas other than carbon dioxide. The mixed gas is the atmosphere or a high concentration gas that has a higher carbon dioxide concentration than the atmosphere. The high concentration gas is discharged from, for example, an internal combustion engine or a factory. The mixed gas of the present embodiment is the atmosphere.

The compressor 11 pumps the mixed gas to the carbon dioxide recovery device 100. The passage switching valve 12 is a three-way valve that switches a passage of exhaust gas from the carbon dioxide recovery device 100. The passage switching valve 12 switches the passage of the exhaust gas toward the atmosphere when the carbon dioxide removed gas is discharged from the carbon dioxide recovery device 100, and switches the passage of the exhaust gas toward the carbon dioxide utilizing device 13 when carbon dioxide is discharged from the carbon dioxide recovery device 100.

The carbon dioxide utilizing device 13 is a device that utilizes carbon dioxide. The carbon dioxide utilizing device 13 may be a storage tank for storing carbon dioxide or a conversion device for converting carbon dioxide into fuel. As the conversion device, a device that converts carbon dioxide into a hydrocarbon fuel such as methane can be used. The hydrocarbon fuel may be gaseous fuel at normal temperature and pressure, or may be liquid fuel at normal temperature and pressure.

The controller 14 includes a well-known microcontroller including a calculation processing device (CPU), a read only memory (ROM), a random access memory (RAM) and the like, and peripheral circuits thereof. The controller 14 performs various calculations and processes based on control programs stored in the ROM, and controls actuations of various devices connected to an output side of the controller 14. The controller 14 of the present embodiment performs an operation control of the compressor 11, an operation control of the carbon dioxide recovery device 100, a passage switching control of the passage switching valve 12 and the like.

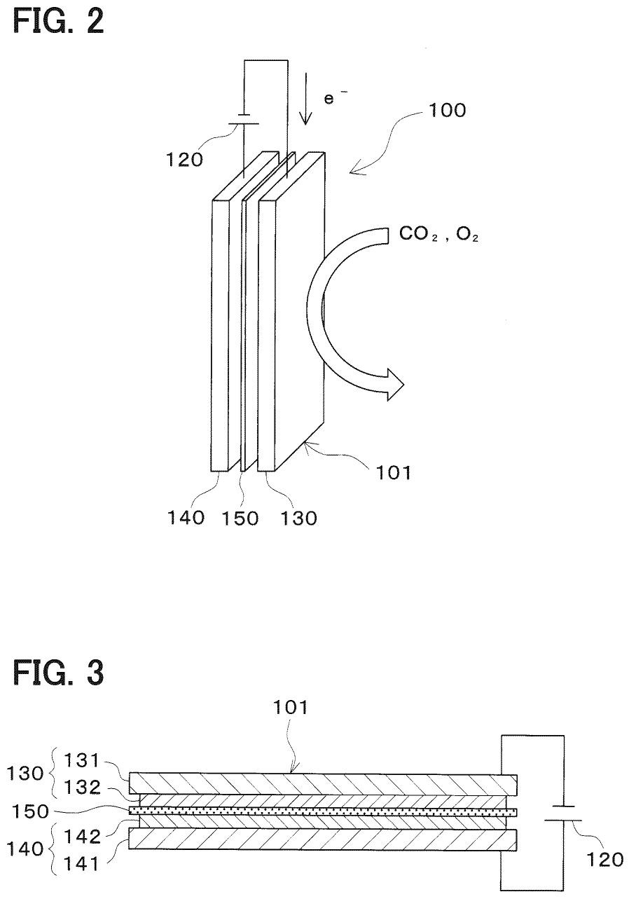

As shown in FIG. 2, the carbon dioxide recovery device 100 includes an electrochemical cell 101. The electrochemical cell 101 includes a working electrode 130, a counter electrode 140, and a separator 150. Multiple electrochemical cells 101 are stacked inside the carbon dioxide recovery device 100.

In the example illustrated in FIG. 2, the working electrode 130, the counter electrode 140, and the separator 150 are each configured in a plate shape. In FIG. 2, the working electrode 130, the counter electrode 140 and the separator 150 are illustrated to have distances therebetween, but actually, these components are arranged to be in contact with each other.

The electrochemical cell 101 may be housed in a container (not shown). The container may define a gas inlet for introducing the mixed gas into the container and a gas outlet for discharging the carbon dioxide removed gas and carbon dioxide out of the container.

The carbon dioxide recovery device 100 is configured to adsorb and desorb carbon oxide by electrochemical reaction, thereby separating and recovering carbon dioxide from the mixed gas. The carbon dioxide recovery device 100 includes a control power supply 120 that applies a predetermined voltage to the working electrode 130 and the counter electrode 140, and can change a potential difference between the working electrode 130 and the counter electrode 140. The working electrode 130 is a negative electrode, and the counter electrode 140 is a positive electrode.

The electrochemical cell 101 can be switched between a carbon dioxide recovery mode in which carbon dioxide is recovered at the working electrode 130 and a carbon dioxide discharge mode in which carbon dioxide is discharged from the working electrode 130 by changing the potential difference between the working electrode 130 and the counter electrode 140. The carbon dioxide recovery mode is a charging mode for charging the electrochemical cell 101, and the carbon dioxide discharge mode is a discharging mode for discharging the electrochemical cell 101.

In the carbon dioxide recovery mode, a first voltage V1 is applied between the working electrode 130 and the counter electrode 140, and electrons flow from the counter electrode 140 to the working electrode 130. At the first voltage V1, the counter electrode potential is greater than the working electrode potential. The first voltage V1 may fall within a range between 0.5 and 2.0 V.

In the carbon dioxide discharge mode, a second voltage V2 is applied between the working electrode 130 and the counter electrode 140, and electrons flow from the working electrode 130 to the counter electrode 140. The second voltage V2 is a voltage lower than the first voltage V1, and a magnitude relationship between the working electrode potential and the counter electrode potential is not limited. That is, in the carbon dioxide discharge mode, the working electrode potential may be lower than, equal to, or greater than the counter electrode potential.

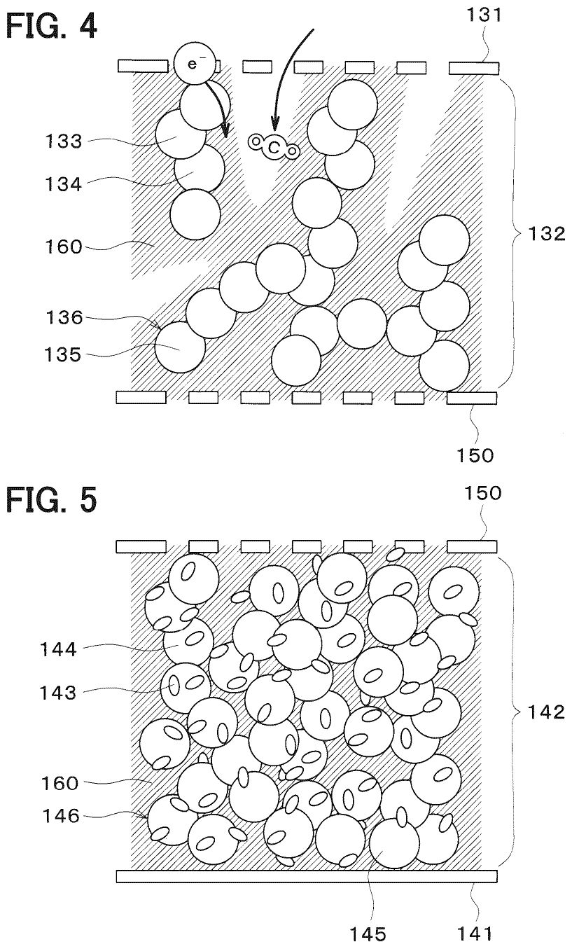

As shown in FIG. 3 and FIG. 4, the working electrode 130 in the electrochemical cell 101 includes a working-electrode current collector 131 and a working electrode film 132. The working-electrode current collector 131 is a porous conductive member that is connected to the control power supply 120 and allows the mixed gas to pass therethrough.

As the working-electrode current collector 131, for example, a carbonaceous material or a metal material can be used. The carbonaceous material constituting the working-electrode current collector 131 may be, for example, carbon paper, carbon cloth, non-woven carbon mat, porous gas diffusion layer (GDL) and the like. The metal material constituting the working-electrode current collector 131 may be, for example, a structure in which a metal such as aluminum (Al), nickel (Ni), stainless steel (SUS), or the like is formed into a mesh shape.

The working electrode film 132 adsorbs and desorbs carbon dioxide from the mixed gas by electrochemical reaction. The working electrode film 132 includes a carbon dioxide adsorbent 133, a working-electrode conductive assistant 134, and a working-electrode binder 135.

Hereinafter, components of the working electrode film 132 such as the carbon dioxide adsorbent 133, the working-electrode conductive assistant 134, and the working-electrode binder 135 are also referred to as working-electrode components 136. In the present embodiment, the working-electrode components 136 are formed in particle shapes.

The carbon dioxide adsorbent 133 is an electroactive species that adsorbs carbon dioxide by receiving electrons and desorbs the adsorbed carbon dioxide by releasing electrons. As the carbon dioxide adsorbent 133, for example, a carbon material, a metal oxide, polyanthraquinone, or the like can be used.

The working-electrode conductive assistant 134 is a conductive material that forms a conductive path to the carbon dioxide adsorbent 133. As the working-electrode conductive assistant 134, for example, a carbon material such as carbon nanotube, carbon black, and graphene can be used.

The working-electrode binder 135 holds the carbon dioxide adsorbent 133 and the working-electrode conductive assistant 134 on the working-electrode current collector 131. Specifically, a mixture of the carbon dioxide adsorbent 133, the working-electrode conductive assistant 134, and the working-electrode binder 135 is formed, and the mixture is bonded to the working-electrode current collector 131.

As the working-electrode binder 135, for example, a conductive resin can be used. The conductive resin may be, for example, an epoxy resin or a fluoropolymer containing Ag or the like as a conductive filler. The fluoropolymer may be, for example, polytetrafluoroethylene (PTFE), or polyvinylidene fluoride (PVDF).

As shown in FIG. 3 and FIG. 5, the counter electrode 140 in the electrochemical cell 101 includes a counter-electrode current collector 141 and a counter electrode film 142. The counter-electrode current collector 141 is a conductive member connected to the control power supply 120. As the counter-electrode current collector 141, the same material as the working-electrode current collector 131 may be used, or a different material may be used.

The counter electrode film 142 exchanges electrons with the working electrode film 132. The counter electrode film 142 includes a counter-electrode active material 143, a counter-electrode conductive assistant 144, and a counter-electrode binder 145.

Hereinafter, components of the counter electrode film 142 such as the counter-electrode active material 143, the counter-electrode conductive assistant 144, and the counter-electrode binder 145 are also referred to as counter-electrode components 146. In the present embodiment, the counter-electrode components 146 are formed in particle shapes.

The counter-electrode active material 143 is an auxiliary electroactive species that exchanges electrons with the carbon dioxide adsorbent 133. The counter-electrode active material 143 is a material capable of taking in and out electrons due to a change in valence of a metal or entering and leaving of charges into and from a π-electron cloud.

The counter-electrode active material 143 may be, for example, a metal complex that can receive and release electrons by changing a valence of a metal ion. Examples of the metal complex include cyclopentadienyl metal complexes such as ferrocene, nickelocene, and cobaltocene, porphyrin metal complexes, and the like.

In the present embodiment, a compound having a ferrocene skeleton is used as the counter-electrode active material 143. Specifically, polyvinyl ferrocene (PVFc) obtained by polymerizing ferrocene is used as the counter-electrode active material 143.

The counter-electrode conductive assistant 144 is a conductive material that forms a conductive path to the counter-electrode active material 143. The counter-electrode conductive assistant 144 is used by being mixed with the counter-electrode active material 143. As the counter-electrode conductive assistant 144, the same material as the working-electrode conductive assistant 134 may be used, or a different material may be used. The counter-electrode conductive assistant 144 is, for example, in the form of particles.

The counter-electrode binder 145 is a material that can hold the counter-electrode active material 143 and the counter-electrode conductive assistant 144 on the counter-electrode current collector 141 and has conductivity. As the counter-electrode binder 145, the same material as the working-electrode binder 135 may be used, or a different material may be used. In the present embodiment, PVDF is used as the counter-electrode binder 145.

The separator 150 is disposed between the working electrode film 132 and the counter electrode film 142. The separator 150 separates the working electrode film 132 from the counter electrode film 142. In other words, the separator 150 prevents physical contact between the working electrode film 132 and the counter electrode film 142. Furthermore, the separator 150 restricts an electrical short circuit between the working electrode film 132 and the counter electrode film 142.

As the material of the separator 150, a cellulose film, a polymer, a composite material of a polymer and a ceramic, or the like can be used. A porous separator may be used as the separator 150.

An electrolyte solution 160, which is an electrolyte material, is provided between the working electrode film 132 and the separator 150 and between the counter electrode film 142 and the separator 150. The working electrode 130 and the counter electrode 140 are covered with the electrolytic solution 160. The electrolytic solution 160 promotes conduction to the carbon dioxide adsorbent 133.

The electrolytic solution 160 may be, for example, an ionic liquid. The ionic liquid is a salt of a liquid having non-volatility under normal temperature and pressure. When the ionic liquid is used as the electrolytic solution 160, the ionic liquid may be gelled to prevent elution of the ionic liquid from the electrochemical cell 101.

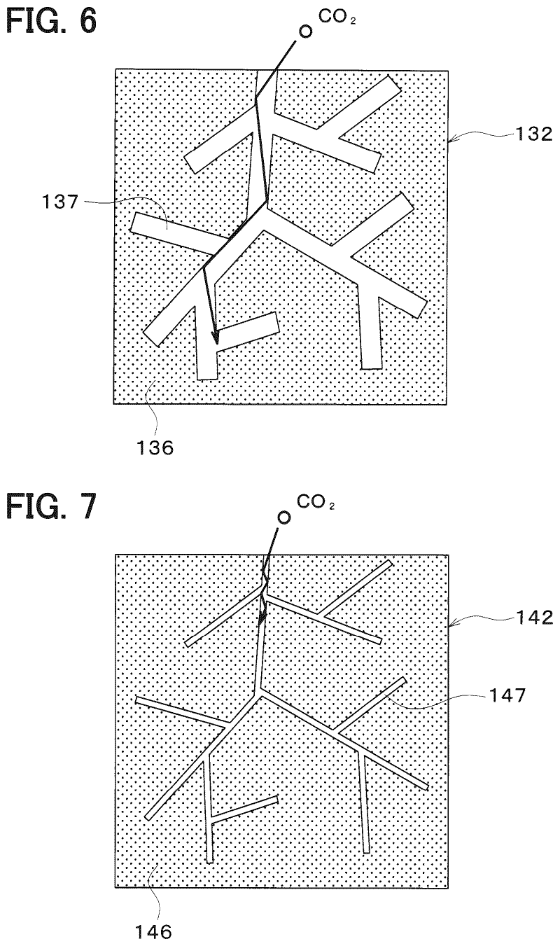

As shown in FIG. 4 and FIG. 6, the working electrode film 132 is formed by being filled with the working-electrode components 136. In the working electrode film 132, working-electrode pores 137 are formed in gaps between the working-electrode components 136. In FIG. 6, for convenience of description, the working-electrode components 136 and the working-electrode pores 137 are schematically illustrated. In the working electrode film 132, carbon dioxide molecules flow into the working-electrode pores 137 from the surface of the working electrode film 132, flow through the working-electrode pores 137, and are diffused.

As shown in FIG. 5 and FIG. 7, the counter electrode film 142 is formed by being filled with the counter-electrode components 146. In the counter electrode film 142, counter-electrode pores 147 are formed in gaps between the counter-electrode components 146. In FIG. 7, for convenience of description, the counter-electrode components 146 and the counter-electrode pores 147 are schematically illustrated.

As shown in FIGS. 4 to 7, an average circle equivalent diameter of the working-electrode pores 137 is equal to or larger than an average circle equivalent diameter of the counter-electrode pores 147. Therefore, a volume porosity of the working electrode film 132 is equal to or greater than a volume porosity of the counter electrode film 142. Therefore, a volume porosity of the working electrode 130 is equal to or greater than a volume porosity of the counter electrode 140.

More specifically, in the present embodiment, the average circle equivalent diameter of the working-electrode pores 137 is larger than the average circle equivalent diameter of the counter-electrode pores 147. Thus, the volume porosity of the working electrode film 132 is larger than the volume porosity of the counter electrode film 142. Therefore, the volume porosity of the working electrode 130 is larger than the volume porosity of the counter electrode 140.

Next, a working electrode forming process of forming the working electrode 130 of the electrochemical cell 101 of the present embodiment will be described. In the working electrode forming process, first, a working electrode mixing process of mixing the working-electrode components 136 is performed.

Subsequently, a heating process of heating the mixed working-electrode components 136 is performed. In the heating process of the present embodiment, the mixed working-electrode components 136 is applied to the working-electrode current collector 131 and then fired. Accordingly, the working electrode film 132 is formed on the surface of the working-electrode current collector 131. The working electrode forming process is completed in this way.

Next, a counter electrode forming process of forming the counter electrode 140 of the electrochemical cell 101 of the present embodiment will be described. In the counter electrode forming process, first, a counter electrode mixing process of mixing the counter-electrode components 146 is performed.

Subsequently, a compression process of compressing the mixed counter-electrode components 146 is performed. In the compression process of the present embodiment, the mixed counter-electrode components 146 is pressed by a press machine to be bonded to the counter-electrode current collector 141. Accordingly, the counter electrode film 142 is formed on the surface of the counter electrode current collector 141. In other words, the counter electrode film 142 is formed by pressure molding. The counter electrode forming process is completed in this way.

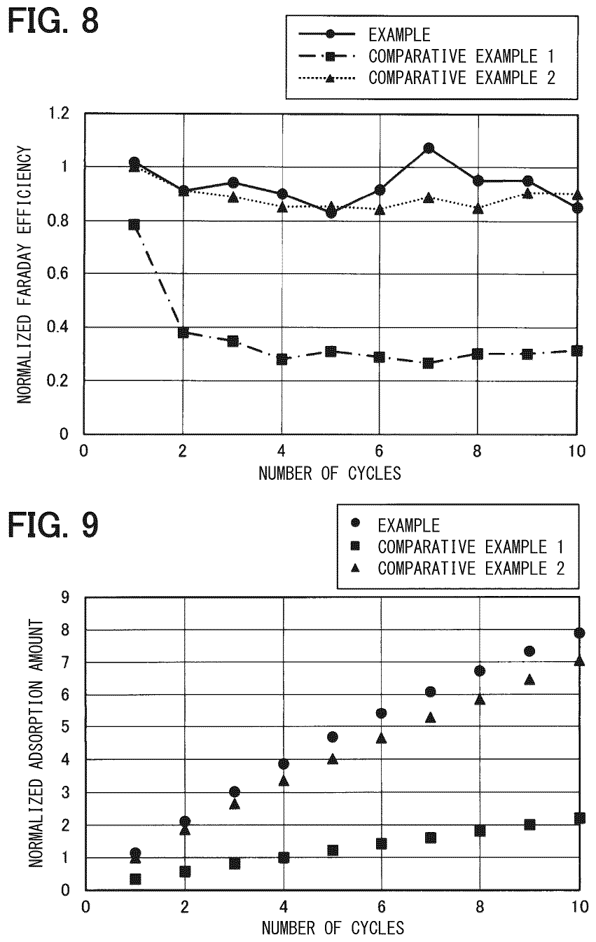

Next, an adsorption efficiency and an adsorption amount of carbon dioxide in the electrochemical cell 101 will be described using an example and comparative examples. Specifically, a combination of the recovery mode and the discharge mode was set as one cycle, and an adsorption Faraday efficiency and a carbon dioxide adsorption amount in each cycle were measured. The results are shown in FIG. 8 and FIG. 9.

A normalized Faraday efficiency, which is a vertical axis of the graph in FIG. 8, is an adsorption Faraday efficiency normalized by setting the adsorption Faraday efficiency at the first cycle in Example, which will be described later, to 1. The adsorption Faraday efficiency indicates a ratio of the number of carbon dioxide molecules adsorbed by the carbon dioxide adsorbent 133 of the electrochemical cell 101 to the number of electrons flowing through the carbon dioxide adsorbent 133.

A normalized adsorption amount, which is a vertical axis of the graph in FIG. 9, is an integrated adsorption amount normalized by setting the integrated adsorption amount in the first cycle in Example as 1. The integrated adsorption amount indicates the total amount of carbon dioxide adsorption up to each cycle.

In Example, an electrochemical cell 101 in which the counter electrode film 142 is formed by pressure molding and the working electrode film 132 is not formed by pressure molding is used. In Comparative Example 1, an electrochemical cell 101 in which the working electrode film 132 is formed by pressure molding and the counter electrode film 142 is not formed by pressure molding is used. In Comparative Example 2, an electrochemical cell 101 in which both the counter electrode film 142 and the working electrode film 132 are not formed by pressure molding is used.

As shown in FIG. 8, the adsorption Faraday efficiency of the electrochemical cell 101 according to Example was about 4 times that of the electrochemical cell 101 according to Comparative Example 1. On the other hand, the adsorption Faraday efficiency in the electrochemical cell 101 was almost unchanged between Example and Comparative Example 2.

As shown in FIG. 9, the integrated adsorption amount of carbon dioxide in the electrochemical cell 101 according to Example was about 4 times the integrated adsorption amount of carbon dioxide in the electrochemical cell 101 according to Comparative Example 1. On the other hand, the integrated adsorption amount of carbon dioxide in the electrochemical cell 101 was almost unchanged between Example and Comparative Example 2.

From the results shown in FIG. 8 and FIG. 9, it was found that when the working electrode film 132 is formed by pressure molding, the diffusibility of carbon dioxide is reduced in the working electrode film 132, and the adsorption performance of carbon dioxide is reduced. On the other hand, it was found that even when the counter electrode film 142 is formed by pressure molding to increase the density, there is almost no influence on the adsorption performance of carbon dioxide as compared with a case where the counter electrode film 142 is not formed by pressure molding.

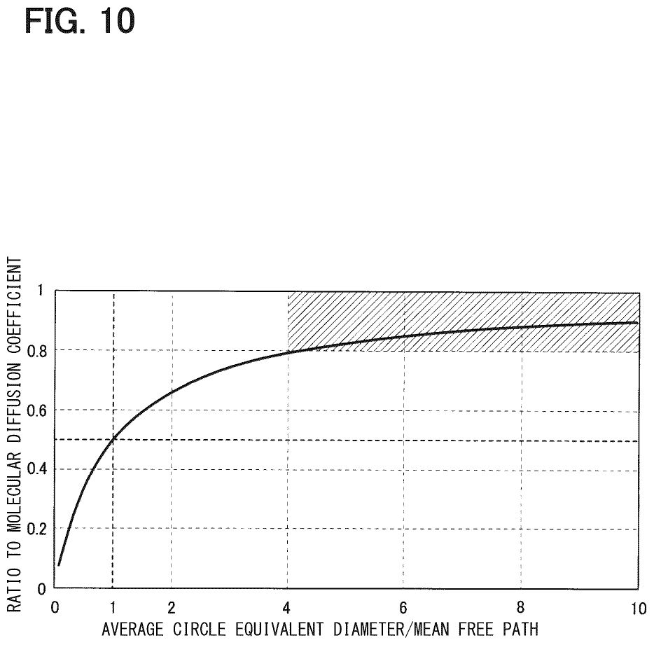

FIG. 10 is a graph showing a relationship between the average circle equivalent diameter of the working-electrode pores 137 and a molecular diffusion coefficient of carbon dioxide in the working electrode film 132 of the present embodiment.

A horizontal axis of the graph in FIG. 10 indicates a value obtained by dividing the average circle equivalent diameter of the working-electrode pores 137 by a mean free path of carbon dioxide. The “mean free path of carbon dioxide” in the present disclosure means a mean free path of carbon dioxide at an operating temperature of the electrochemical cell 101.

A vertical axis of the graph in FIG. 10 indicates a ratio with respect to a molecular diffusion coefficient of carbon dioxide in gas. If the ratio with respect to the molecular diffusion coefficient is greater than 0.5, molecular diffusion predominates.

As shown in FIG. 10, by setting the average circle equivalent diameter of the working-electrode pores 137 to be 4 times or more the mean free path of carbon dioxide, the molecular diffusion of carbon dioxide becomes 80% or more. By setting the average circle equivalent diameter of the working-electrode pores 137 to be 10 times or more the mean free path of carbon dioxide, the molecular diffusion of carbon dioxide becomes 90% or more.

Therefore, it is preferable that the average circle equivalent diameter of the working-electrode pores 137 is 4 times or more the mean free path of carbon dioxide. In addition, it is more preferable that the average circle equivalent diameter of the working-electrode pores 137 is 10 times or more the mean free path of carbon dioxide.

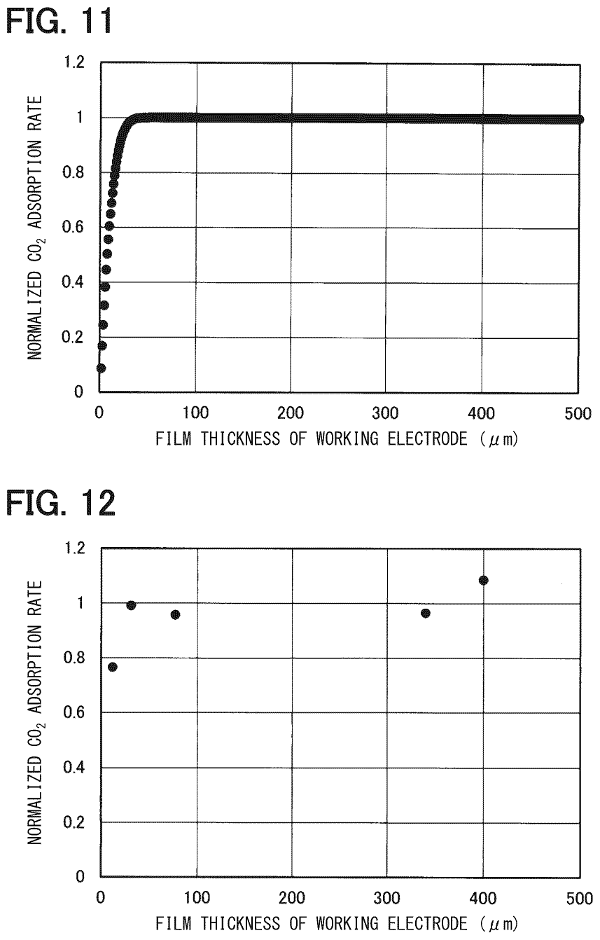

The present inventors examined a film thickness of the working electrode film 132. FIG. 11 is a graph showing a relationship between the film thickness of the working electrode film 132 and a carbon dioxide adsorption rate calculated by calculation (hereinafter, referred to as calculation data).

A normalized CO₂ adsorption rate, which is a vertical axis of the graph in FIG. 11, is a carbon dioxide adsorption rate normalized by setting a saturation value of the carbon dioxide adsorption rate in the calculation data to 1. The saturation value of the carbon dioxide adsorption rate in the calculation data refers to an average value of the carbon dioxide adsorption rate when the thickness of the working electrode film 132 is 50 to 500 μm.

As shown in FIG. 11, when the thickness of the working electrode film 132 is increased, the carbon dioxide adsorption rate is increased. When the thickness of the working electrode film 132 becomes larger than a specific film thickness, the carbon dioxide adsorption rate does not increase anymore and reaches a peak. The carbon dioxide adsorption rate at this time is referred to as an upper limit value. In the present embodiment, the thickness of the working electrode film 132 is set to be equal to or less than the film thickness (30 μm in the present example) at which the carbon dioxide adsorption rate is the upper limit value. The thickness of the working electrode film 132 is equal to or less than the thickness of the counter electrode film 142.

The following Equation 1 is an equation for deriving a diffusion reaching concentration c from a diffusion equation of gas in the carbon dioxide recovery system of the present embodiment.

$$C = 1 - erf ( \frac{xSa η}{\sqrt{4 Dt}} ) \qquad ( 1 )$$

In Equation 1, x is the film thickness of the working electrode film 132, t is an operating time of the carbon dioxide recovery system 10, Sa is a specific surface area of the working electrode film 132, η is a distance conversion coefficient, and D is the diffusion coefficient of carbon dioxide.

The distance conversion coefficient η is a numerical value of 1 to 100. The diffusion distance of carbon dioxide in the working electrode film 132 of the present embodiment is a value obtained by correcting the film thickness of the working electrode film 132 with the specific surface area Sa, and a ratio between the specific surface area Sa and a geometric surface area of the working electrode film 132 is used. Specifically, the distance conversion coefficient η can be calculated as follows.

FIG. 12 is a graph showing a relationship between the film thickness of the working electrode film 132 and a actually measured adsorption rate (hereinafter, referred to as actual measurement data).

A normalized CO₂ adsorption rate, which is a vertical axis of the graph in FIG. 12, is a carbon dioxide adsorption rate normalized by setting a saturation value of the carbon dioxide adsorption rate in the actual measurement data to 1. The saturated value of the carbon dioxide adsorption rate in the actual measurement data refers to an average value of the carbon dioxide adsorption rates at the right four points in FIG. 12.

The distance conversion coefficient η when the calculation data shown in FIG. 11 is fitted to the actual measurement data shown in FIG. 12 is calculated. In the present embodiment, the calculated distance conversion coefficient η is 25.

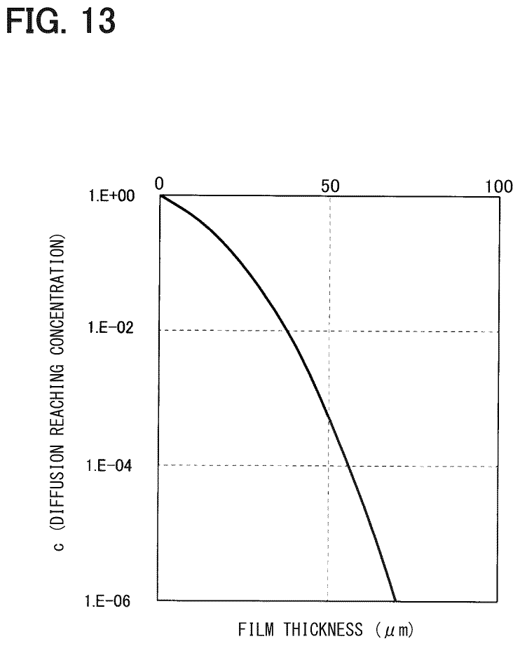

FIG. 13 shows a result of calculating a relationship between the film thickness x of the working electrode film 132 and the diffusion reaching concentration c by applying the distance conversion coefficient η calculated in this way to Equation 1.

As shown in FIG. 13, at a depth of about 40 μm from the surface of the working electrode film 132, carbon dioxide can reach 10⁻², that is, 1% of the total amount. In other words, 99% of carbon dioxide is present between the surface of the working electrode film 132 and the depth of 40 μm. Therefore, in the present embodiment, the film thickness x of the working electrode film 132 is set so as to satisfy c>10⁻⁴ in Equation 1.

As described above, in the electrochemical cell 101 of the present embodiment, the volume porosity of the working electrode 130 is equal to or greater than the volume porosity of the counter electrode 140. More specifically, the volume porosity of the working electrode film 132 is set to be equal to or greater than the volume porosity of the counter electrode film 142. Specifically, the volume porosity of the working electrode film 132 is set to be greater than the volume porosity of the counter electrode film 142.

According to this configuration, the diffusibility of carbon dioxide can be improved in the working electrode film 132, and thus the permeability of carbon dioxide can be secured. As a result, the adsorption performance of carbon dioxide can be improved.

It is not necessary to diffuse carbon dioxide in the counter electrode 140, and it is only necessary that the electrolytic solution 160 is impregnated. Therefore, in the present embodiment, the volume porosity of the counter electrode film 142 is reduced to increase the density. Specifically, the counter electrode film 142 is formed by pressure molding.

According to the above-described configuration, since the thickness of the entire electrochemical cell 101 (that is, the length of the electrochemical cell 101 in the stacking direction) is reduced, the number of electrochemical cells 101 accommodated in one carbon dioxide recovery device 100 can be increased. As a result, it is possible to increase the adsorption amount of carbon dioxide as a whole of the carbon dioxide recovery device 100. That is, the adsorption performance of carbon dioxide per unit volume can be improved.

In the electrochemical cell 101 of the present embodiment, the average circle equivalent diameter of the working-electrode pores 137 is set to be equal to or larger than the average circle equivalent diameter of the counter-electrode pores 147. Specifically, the average circle equivalent diameter of the working-electrode pores 137 is larger than the average circle equivalent diameter of the counter-electrode pores 147.

According to the above-described configuration, in the working electrode 130, carbon dioxide molecules flowing into the working-electrode pores 137 from the surface of the working electrode film 132 are easily diffused. Therefore, the diffusion rate of carbon dioxide is increased in the working electrode film 132. Accordingly, the adsorption rate of carbon dioxide can be improved. As a result, the adsorption performance of carbon dioxide can be improved.

In the present embodiment, the average circle equivalent diameter of the working-electrode pores 137 is set to be 4 times or more the mean free path of carbon dioxide at the operating temperature. According to the above-described configuration, the diffusion rate of carbon dioxide in the working-electrode pores 137 can be improved, and the adsorption rate of carbon dioxide can be improved. As a result, the adsorption performance of carbon dioxide can be improved.

### Other Embodiments

The present disclosure is not limited to the embodiments described above, and various modifications can be made as follows within a range not departing from the spirit of the present disclosure.

For example, in the above-described embodiment, an example in which the press working is performed by the press machine in the compression process of the counter electrode forming process has been described, but the press working is not limited to this aspect. For example, the press working may be performed by a roll press or a hydraulic press.

What is claimed is:

1. An electrochemical cell comprising:
a working electrode configured to adsorb and desorb a recovery target gas from a mixed gas containing the recovery target gas by electrochemical reaction; and
a counter electrode configured to exchange electrons with the working electrode, wherein
the working electrode has a volume porosity that is equal to or greater than a volume porosity of the counter electrode.

2. The electrochemical cell according to claim 1, wherein
the working electrode includes a working electrode film,
the counter electrode includes a counter electrode film, and
the working electrode film has a volume porosity that is equal to or greater than a volume porosity of the counter electrode film.

3. The electrochemical cell according to claim 2, wherein
the working electrode film has a plurality of working-electrode pores,
the counter electrode film has a plurality of counter-electrode pores, and
the plurality of working-electrode pores has an average circle equivalent diameter that is equal to or larger than an average circle equivalent diameter of the plurality of counter-electrode pores.

4. The electrochemical cell according to claim 1, wherein
the working electrode has a working electrode film,
the working electrode film has a plurality of working-electrode pores, and
the plurality of working-electrode pores has an average circle equivalent diameter that is four times or more a mean free path of the recovery target gas at an operating temperature.

5. The electrochemical cell according to claim 1, wherein
the counter electrode includes a counter electrode film, and
the counter electrode film is formed by pressure molding.

6. The electrochemical cell according to claim 1, wherein
the working electrode includes a working electrode film,
the counter electrode includes a counter electrode film, and
the working electrode film has a thickness that is equal to or less than a thickness of the counter electrode film.

7. The electrochemical cell according to claim 1, wherein
the working electrode includes a working electrode film, and
the working electrode film has a thickness that is equal to or less than a film thickness at which an adsorption rate of the recovery target gas becomes an upper limit value.
